(19) United States
(12) Patent Application Publication
(10) Pub. No.: US 2017/0102721 A1
(43) Pub. Date: Apr. 13, 2017

(54) Control Member for a Fluid Regulating Device

(71) Applicant: EMERSON PROCESS MANAGEMENT REGULATOR TECHNOLOGIES, INC., McKinney, TX (US)

(72) Inventor: Christopher Joseph Jack Hunt, Redondo Beach, CA (US)

(73) Assignee: EMERSON PROCESS MANAGEMENT REGULATOR TECHNOLOGIES, INC., McKinney, TX (US)

(21) Appl. No.: 15/291,765

(22) Filed: Oct. 12, 2016

Related U.S. Application Data
(60) Provisional application No. 62/240,258, filed on Oct. 12, 2015.

(51) Int. Cl. G05D 16/06; F16K 1/34; F16K 31/126

(52) U.S. Cl. CPC G05D 16/0658; F16K 31/1262; F16K 1/34

(57) ABSTRACT

A control member for a fluid regulating device. The control member includes a top side and a bottom side. The top side is adapted to engage a valve seat of the fluid regulating device when the control member is arranged in a closed position. The control member also includes a means for reducing a suction force exerted on the bottom side of the control member by fluid flowing proximate to the control member. In one example, the means takes the form of a rim that extends outwardly from the bottom side to a position below the bottom side. The rim is configured to reduce a downward force exerted on the bottom side of the control member by directing fluid flowing through the fluid passageway away from the bottom side of the control member.

### FIELD OF THE INVENTION

The present invention relates generally to fluid regulating devices such as fluid or gas regulators and, more specifically, to a control member for a fluid regulating device.

### BACKGROUND

Regulators are commonly employed in fluid or gas distribution systems to control the pressure in the system downstream of the regulator. As is known, the pressure at which a typical gas distribution system supplies gas may vary according to the demands placed on the system, the climate, the source of the supply, and/or other factors. However, most end-user facilities equipped with gas appliances such as, for example, furnaces, and ovens, require the gas to be delivered in accordance with predetermined pressure parameters. Therefore, such distribution systems use gas regulators to ensure that the delivered gas meets the requirements of the end-user facilities.

Direct-operated fluid regulators are primarily designed for industrial and commercial applications supplying fluids, such as natural gas and propane, to furnaces, burners, and other appliances and are generally well known in the art. Fluid regulators are typically used to regulate the pressure of a fluid to a substantially constant value. Specifically, a fluid regulator has an inlet that typically receives a supply fluid at a relatively high pressure and provides a relatively lower and substantially constant pressure at an outlet. To regulate the downstream pressure, fluid regulators commonly include a sensing element or diaphragm to sense an outlet pressure in fluid communication with a downstream pressure.

### SUMMARY

In accordance with a first exemplary aspect of the invention, a control member for a fluid regulating device is provided. The control member includes a top side adapted to engage the valve seat when the control member is arranged in a closed position, a bottom side, and a means for reducing a suction force exerted on the bottom side of the control member by fluid flowing proximate to the control member.

In accordance with a second exemplary aspect of the invention, a control member for a fluid regulating device is provided. The control member includes a top side, a bottom side, and a rim. The top side is adapted to engage a valve seat of the fluid regulating device when the control member is arranged in a closed position. The rim extends outwardly from the bottom side to a position below the bottom side. The rim is configured to reduce a downward force exerted on the bottom side of the control member by directing fluid flowing through the fluid passageway away from the bottom side of the control member.

In accordance with a third exemplary aspect of the invention, a fluid regulating device is provided. The fluid regulating device includes a valve body, an actuator assembly coupled to the valve body, a valve seat, and a stem assembly. The valve body has an inlet, an outlet, and a fluid passageway defined between the inlet and the outlet. The actuator assembly includes an upper casing, a lower casing secured to the upper casing, and a diaphragm assembly disposed between the upper casing and the lower casing. The valve seat is disposed in the valve body along the fluid passageway. The stem assembly is operatively connected to the diaphragm assembly to move with the diaphragm assembly. The stem assembly includes a valve stem and a control member operatively connected to the valve stem and movable relative to the valve seat to control fluid flow through the fluid passageway. The control member includes a body having a top side configured to engage the valve seat when the control member is in a closed position and a bottom side. The control member further includes a rim extending outwardly from the body to a position below the bottom side. The rim configured to direct fluid flowing through the fluid passageway away from the bottom side of the control member.

In accordance with a fourth exemplary aspect of the invention, a fluid regulating device is provided. The fluid regulating device includes a valve body, an actuator assembly coupled to the valve body, a valve seat, and a stem assembly. The valve body has an inlet, an outlet, and a fluid passageway defined between the inlet and the outlet. The actuator assembly includes an upper casing, a lower casing secured to the upper casing, and a diaphragm assembly disposed between the upper casing and the lower casing. The valve seat is disposed in the valve body along the fluid passageway. The stem assembly is operatively connected to the diaphragm assembly to move with the diaphragm assembly. The stem assembly includes a valve stem and a control member operatively connected to the valve stem and movable relative to the valve seat to control fluid flow through the fluid passageway. The control member comprises a top side configured to engage the valve seat when the control member is in a closed position, a bottom side, and a perimeter edge. The perimeter edge has a first portion between the top and bottom sides and a second portion extending outwardly from the first portion to a position below the bottom side. The second portion configured to direct fluid flowing through the fluid passageway away from the bottom side of the control member.

In further accordance with any one or more of the foregoing first, second, third, or fourth exemplary aspects, a control member and/or a fluid regulating device may include any one or more of the following further preferred forms.

In one preferred form, the means for reducing a suction force exerted on the bottom side of the control member includes a rim extending outwardly from the bottom side to a position below the bottom side. The rim is configured to reduce a downward force exerted on the bottom side of the control member by directing fluid flowing through the fluid passageway away from the bottom side of the control member.

In another preferred form, the rim is radially aligned with a circumferential edge of the body of the control member.

In another preferred form, the control member includes a body including the top side and the bottom side. The means for reducing a suction force exerted on the bottom side of the control member extends outwardly from the body to a position below the bottom side.

In another preferred form, the control member includes a body having a first annular portion and a second annular portion having a diameter greater than a diameter of the first annular portion, and the means for reducing a suction force exerted on the bottom side of the control member includes the second annular portion.

In another preferred form, the control member includes a body having a perimeter edge, and the means for reducing a suction force exerted on the bottom side of the control member includes a portion of the perimeter edge.

In another preferred form, a fastener connects the control member to the valve stem. The fastener can be recessed within the control member.

In another preferred form, a through-bore is formed through the control member, and a fastener that connects the control member to the valve stem is arranged in the through-bore between the top and bottom sides of the control member.

In another preferred form, a through-bore is formed through the control member. The through-bore is configured to receive a fastener for connecting the control member to the valve stem.

In another preferred form, the rim circumferentially surrounds the bottom side of the control member.

In another preferred form, the second portion of the perimeter edge circumferentially surrounds the bottom side of the control member.

In another preferred form, the second portion of the perimeter edge has a diameter greater than a diameter of the first portion of the perimeter edge.

In another preferred form, the second portion of the perimeter edge is radially aligned with the first portion of the perimeter edge.

### BRIEF DESCRIPTION OF THE DRAWINGS

FIG. 1 is a cross-sectional view of a fluid regulating device having a conventional control member.

FIG. 2A is a perspective view of a control member constructed in accordance with the teachings of a first disclosed example of the present invention.

FIG. 2B is a cross-sectional view illustrating the control member of FIG. 2A connected to a valve stem of the fluid regulating device of FIG. 1.

FIG. 3 is a perspective view of a control member constructed in accordance with the teachings of a second disclosed example of the present invention.

FIG. 4 is a graph depicting downstream pressure as a function of flow rate for a fluid regulating device outfitted with the conventional control member of FIG. 1, a fluid regulating device outfitted with the control member of FIGS. 2A and 2B, and a fluid regulating device outfitted with the control member of FIG. 3.

### DETAILED DESCRIPTION OF THE PREFERRED EMBODIMENTS

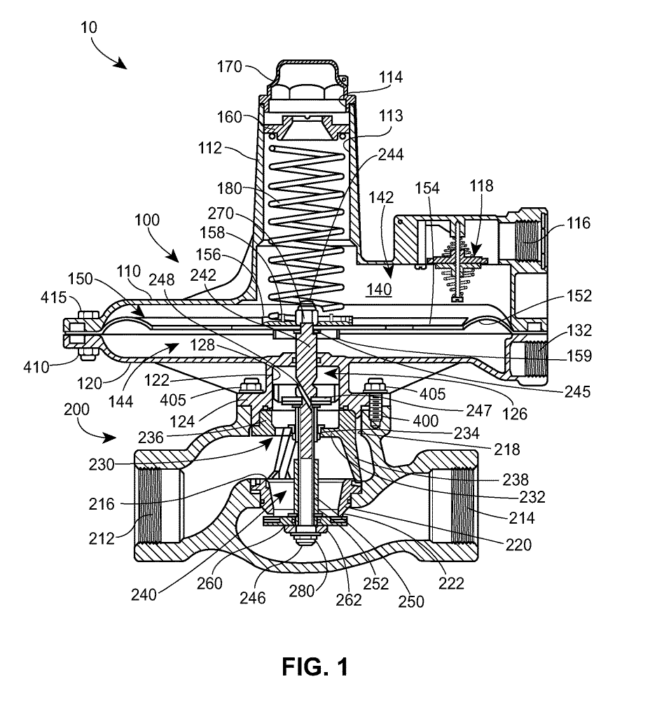

FIG. 1 illustrates a fluid regulator 10 that generally includes an actuator assembly 100 and a valve body 200. The actuator assembly 100 is coupled (e.g., secured) to the body 200 with threaded studs 400 and locknuts 405, though the actuator assembly 100 can be coupled to the body 200 by any other well-known means.

The actuator assembly 100 has an upper casing 110 coupled to a lower casing 120 with nuts 410 and bolts 415, or any other well-known means, which when assembled define a cavity 140. A diaphragm assembly 150, as described in more detail below, is secured between upper casing 110 and lower casing 120, and divides the cavity 140 into an upper portion 142 above the diaphragm assembly 150 and a lower portion 144 below the diaphragm assembly 150.

The upper casing 110 has a cylindrical wall 112 extending therefrom. The cylindrical wall 112 has a threaded inner surface 113 and defines an opening 114 in one end. An adjusting screw 160 is threaded into the cylindrical wall 112 of upper casing 110 and a closing cap 170 is threaded into the opening 114 of the cylindrical wall 112 to protect adjusting screw 160 and prevent debris from entering actuator assembly 100. A spring 180 is disposed in an upper portion 142 of cavity 140 between the adjusting screw 160 and the diaphragm assembly 150 to bias the diaphragm assembly 150 toward the body 200. Another opening 116 is also formed in upper casing 110 to fluidly couple the upper portion 142 of cavity 140 with the atmosphere. In the particular example shown, a stabilizer assembly 118, which is well-known in the art, is disposed proximate the opening 114 to control the flow of fluid into and out of the upper portion 142 of cavity 140 through the opening 116.

The lower casing 120 has a wall 122 extending therefrom. The wall 122 has a cylindrical inner surface 128 that ends at a shoulder and defines a portion of balancing cavity 126. A flange 124 extends outward from the wall 122 and has apertures to receive threaded studs 400. A threaded opening 132 is also formed in lower casing 120 and can be used to connect the lower casing 120 to an external control line (not shown), which can be used to fluidly couple the lower portion 144 of the cavity 140 and a downstream pipe, as discussed in more detail below.

The diaphragm assembly 150 generally includes a diaphragm 152, a diaphragm plate 154, a spring seat 156, and top and bottom sealing washers 158, 159. The diaphragm 152 is secured at its outer edge between upper casing 110 and lower casing 120 and has an opening formed in the center to receive a stem 242 of a stem assembly 240. The diaphragm plate 154 is positioned adjacent the diaphragm 152 to provide support to the inner portion of diaphragm 152. The spring seat 156 is positioned adjacent the diaphragm plate 154 to receive one end of spring 180. Top and bottom sealing washers 158, 159 are positioned on opposite sides of diaphragm 152 to secure the diaphragm 152 and the diaphragm plate 154 to the stem 242, as described in more detail below, and to provide a seal to prevent fluid flow between the upper portion 142 and the lower portion 144 of cavity 140 through the opening in the diaphragm 152.

The body 200 defines a fluid inlet 212, a fluid outlet 214, and a fluid passage 216 fluidly connecting the inlet 212 and the outlet 214. An opening 218 is formed in the body 200 and is in fluid communication with the inlet 212 and aligned with the fluid passage 216. The regulator 10 also includes a seat insert 220, a cage 230, and the stem assembly 240. The seat insert 220 is secured in the fluid passage 216 and provides or defines a seating surface 222. The cage 230 is positioned in the opening 218 and has a top wall 232, a generally cylindrical side wall 236 that extends from one side of top wall 232 and defines a second portion of the cylindrical balancing cavity 126, and a plurality of support legs 238 that extend from another side of top wall 232, opposite side wall 236, to support cage 230 on the body 200. An aperture 234 is formed through a central portion of top wall 232 to receive a sleeve 250 of the stem assembly 240.

The stem assembly 240 generally includes the stem 242, the sleeve 250, the control member 260, and a registration disk 262. The stem 242 is a generally cylindrical rod that extends through an aperture in the lower casing 120 and has a first threaded end 244 that extends through openings in the bottom sealing washer 159, the diaphragm 152, the diaphragm plate 154, the spring seat 156, and the top sealing washer 158. The bottom sealing washer 159 engages a shoulder 245 formed on the stem 242 and a nut 270 is threaded onto first threaded end 244 to compress the bottom sealing washer 159, the diaphragm 152, the diaphragm plate 154, the spring seat 156, and the top sealing washer 158 between shoulder 245 and nut 270, and secure the diaphragm assembly 150 to the stem assembly 240. The sleeve 250 is positioned over a portion of the stem 242 to provide an annular space 252 between the stem 242 and the sleeve 250 from a bottom end of sleeve 250 to an area proximate a hole 248 formed through the stem 242, and extends through the aperture 234 in the cage 230. The control member 260, which in this example is a valve disk, is positioned over an end of the sleeve 250 and the registration disk 262 is positioned over a second threaded end 246 of the stem 242, adjacent the control member 260. The control member 260 and registration disk 262 are secured to the stem 242 and the sleeve 250 by a nut 280. The control element 260 is thus operatively coupled to the stem 242, such that the control element 260 is, responsive to movement of the stem 242, movable relative to the seating surface 222 to control fluid flow through the fluid passage 216. More specifically, the control member 260 is movable between a closed position, wherein the control member 260 sealingly engages the seating surface 222 to prevent fluid flow through the fluid passage 216, and an open position, wherein the control member 260 is spaced from the seating surface 222 and fluid can flow through the fluid passage 216.

In operation, when the control member 260 is in an open position (i.e., spaced away from the seating surface 222), process fluid enters the body 200 through the inlet 212 at an inlet pressure, and flows through the seat insert 220, past control member 260, and exits the body 200 through the outlet 214 at a downstream pressure. A portion of the fluid at downstream pressure P2 flows through the external control line (not shown) and is communicated to the lower portion 144 of cavity 140 through the opening 132 in the lower casing 120. Increased demand for the operating fluid at the outlet 214 will cause the downstream pressure to decrease, which will decrease the pressure in the lower portion 144 of the cavity 140, and, in turn, the upward pressure exerted on the diaphragm 152, thereby allowing the spring 180 to move the diaphragm 152 and stem assembly 240 downward. This, in turn, opens the control member 260 further (i.e., moves the control member 260 further away from the seating surface 222) and supplies more operating fluid to the system to meet the increased demand. Conversely, decreased demand for the operating fluid at the outlet 214 will cause the downstream pressure to increase, which will increase the pressure in the lower portion 144 of the cavity 140, and, in turn, the upward pressure exerted on the diaphragm 152, thereby moving the diaphragm 152 and stem assembly 240 upward. This, in turn, closes the control member 260 further (i.e., moves the control member 260 closer to the seating surface 222) to decrease the supply of the operating fluid to the system to meet the decreased demand.

When the regulator 10 is operating at steady-state conditions, the stabilizers of stabilizer assembly 118 are closed and only a small hole is open to stabilize normal operation. When the regulator 10 responds to an increase in downstream pressure, the pressure in the lower portion 144 of the cavity 140 increases and the diaphragm 152 moves upward. As diaphragm 152 moves upward, movement of air in the upper portion 142 of the cavity 140 can force a lower vent stabilizer of the stabilizer assembly 118 upward, which allows the air in the upper portion 142 of the cavity 140 to vent to the atmosphere rapidly and minimize any lag in movement of the diaphragm 152. When the regulator 10 responds to a decrease in downstream pressure, the pressure in the lower portion 144 decreases and the diaphragm 152 moves downward. As the diaphragm 152 moves downward, air rushes through the stabilizer assembly 118 to fill the partial vacuum created in the upper portion 142 of the cavity 140, which forces an upper vent stabilizer of the stabilizer assembly 118 to close. Air flowing through webs of the upper vent stabilizer can then open the lower vent stabilizer to allow air from the atmosphere to flow into the upper portion 142 of the cavity 140.

When the control member 260 is open, the process fluid flows from inlet 212, through seat insert 220 (and thus the fluid passage 218), and over the edge of the control member 260 to outlet 214. As the process fluid flows through the seat insert 220 and over the edge of the control member 260, the process fluid may exert an upward or downward force on the control member 260, which can in turn interfere with the operation of the regulator 10 by counteracting or adding to the upward force applied by the outlet pressure on the diaphragm 152. This is particularly problematic in high flow situations, whereby the process fluid, flowing or traveling at high velocities on the flat underside of the control member 260, generates a suction (i.e., downward) force that acts to move the control member 260 further away from the seating surface 222 than desired, thereby opening the regulator 10 more than desired. This is also problematic when the regulator 10 operates at low outlet pressures, whereby even a small suction force generated by the process fluid flowing or traveling on the flat underside of the control member 260 can act to move the control member 260 further from the seating surface 222 than desired. In both situations, the downstream outlet pressure may be boosted out of accuracy, thereby limiting the capacity of the regulator 10.

The present disclosure thus provides a control member 500 that, when implemented in the regulator 10, minimizes the suction force generated by the process fluid in high flow situations and at low outlet pressures, thereby reducing, if not removing, undesirable “boost”, and improving the accuracy of the regulator 10. To this end, the control member 500 is generally constructed so that high-velocity fluid flow is substantially kicked off, or directed away from, the underside of the valve member 500. This can be accomplished in any number of different ways, as will be described below.

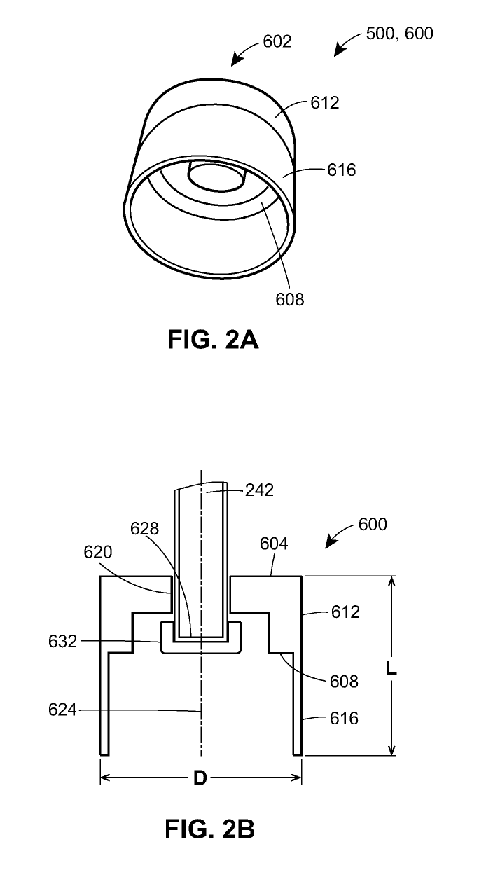

FIGS. 2A and 2B illustrate one example of such a control member 500, taking the form of a valve pad 600. The valve pad 600 has a body 602 defined by a top side or surface 604, a bottom side or surface 608, and a circumferential edge 612 between the top side 604 and the bottom side 608. The valve pad 600 also includes a downwardly extending rim or lip 616, which can be integrally formed with the body 602 or can be separately manufactured and subsequently coupled to the body 602. The rim or lip 616 extends from a portion of the body 602 (e.g., the circumferential edge 612) to a position below the bottom side 608. The circumferential edge 612 and the rim 616 can, but need not, have a combined length L that is greater than the diameter D of the valve pad 600. In the illustrated example, the rim or lip 616 is radially aligned with the circumferential edge 612, such that the circumferential edge 612 and the rim 616 have the same diameter. In other examples, however, the rim or lip 616 can be positioned radially inward or radially outward of the circumferential edge 612.

As best illustrated in FIG. 2B, the valve pad 600 has a through-bore 620 formed therethrough along a central longitudinal axis 624 of the pad 600. The through-bore 620 is sized to receive an end 628 of the stem 242. The end 628 of the stem 242 is, in this example, threaded, such that a fastener 632 (e.g., a retaining nut) with a threaded inner surface can be threaded onto the stem 242 to couple (e.g., fixedly secure) the stem 242 to the valve pad 600, as is illustrated in FIG. 2B. It will be appreciated that the fastener 632 is, as a result of the structure of the valve pad 600, recessed within the valve pad 600.

When the valve pad 600 is so coupled to the stem 242, and the regulator 10 is in operation, the valve pad 600 minimizes the suction force that would otherwise be generated by the process fluid in high flow situations and at low outlet pressures. When the valve pad 600 is open, such that the process fluid flows from the inlet 212 and through the seat insert 220 (and thus the fluid passage 218), the process fluid will flow along the circumferential edge 612 and the rim or lip 616 to the outlet 214. While some process fluid may, in the process, reach the bottom surface 608 of the valve pad 600, the rim or lip 616 will keep or direct most of the process fluid flow away from the bottom surface 608 of the valve pad 600 (i.e., the underside of the valve pad 600). As a result, only a minimal amount of suction force will be generated by the process fluid and exerted on the bottom surface 608 of the valve pad 600, even in high flow situations and at low outlet pressures. In turn, the valve pad 600 helps to reduce unnecessary and undesirable “boost”, facilitating a more accurate pressure regulator 10. Moreover, by recessing the fastener 632 (i.e., the connection between the stem 242 and the valve pad 600) within the valve pad 600, the fastener 632 is substantially not exposed to the process fluid flowing through the regulator 10. This also helps to reduce the suction force that would otherwise be generated by process fluid flowing across the bottom of the fastener 632, particularly when the process fluid is flowing at high velocities.

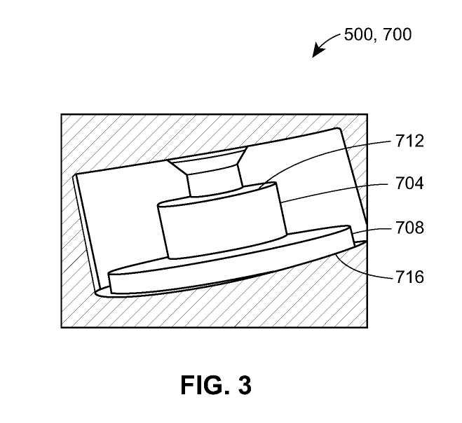

It will be appreciated that the control member 500 can vary and still facilitate a more accurate regulator 10, as intended. The control member 500 can, in some examples, take the form of a valve plug, a valve disc, or other type of control member. The control member 500 can vary in shape, size, and/or construction. As illustrated in FIG. 3, for example, the control member 500 can take the form of a stepped valve pad 700 having a plurality of (in this case, two) differently sized annular portions 704, 708. The first annular portion 704 defines a top side or surface 712 and the second annular portion 708 defines a bottom side or surface 716. The second annular portion 708 has a larger diameter than the first annular portion 704, such that process fluid flowing through the regulator 10 is largely kept or directed away from the bottom surface 716, thereby minimizing the amount of suction force generated by the process fluid and exerted on the bottom surface 716. Moreover, instead of including the rim or lip 616, the control member 500 may kick process fluid off the bottom surface 608 by utilizing a concave-shaped bottom surface 608, a different shape for the bottom surface 608, or by utilizing other features that accomplish the same function. Further yet, in some cases, the amount of “boost” provided by the control member 500 may be increased or decreased, as desired based on the given application, by adjusting the height of the rim 616, the diameter of the control member 500, the castling of the rim 616, or in some other manner.

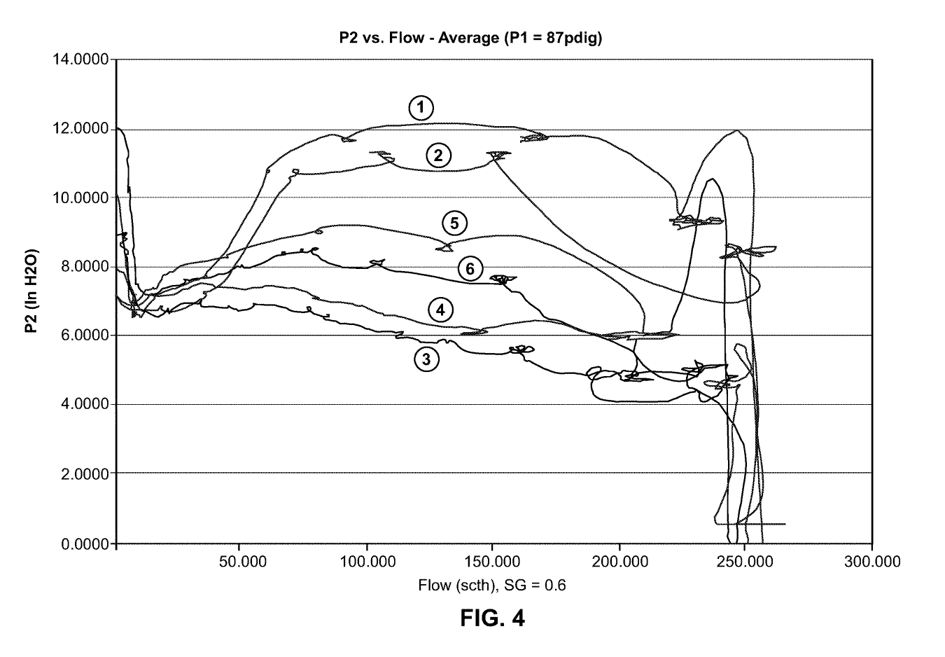

Turning now to FIG. 4, the performance of a fluid regulating device outfitted with a conventional control member, such as the control member 260, will now be compared with the performance of a fluid regulating device outfitted with a control member constructed in accordance with the teachings of the present invention, such as the valve pad 600 or the valve pad 700.

FIG. 4 illustrates two flow curves ((1) and (2)) of a fluid regulating device with a conventional control member, such as the control member 260, two flow curves ((3) and (4)) of a regulator with a control member constructed in accordance with the teachings of the present invention, such as the valve pad 600, and two flow curves ((5) and (6)) of a fluid regulating device with another control member constructed in accordance with the teachings of the present invention, such as the valve pad 700. In each of the tests represented by the data shown in the graph provided in FIG. 4, the fluid regulating device was set with an inlet pressure of 87 pounds per square inch gage (psig) and the outlet pressure P2 was measured as a function of the flow rate. The y-axis of the graph shown in FIG. 4 corresponds to the measured outlet pressure P2, measured in psig, and the x-axis of the graph shown in FIG. 4 corresponds to the flow rate in standard cubic feet per hour (scfh). As seen in the FIG. 4 graph, the output pressure P2 is similar for each of the fluid regulating devices at low flow rates (0-50,000 scfh), but spikes, or dramatically increases, at higher flow rates (50,000-250,000 scfh) for the fluid regulating device with the conventional control member. This spike is the result of the suction force generated by fluid flowing at high velocities along the underside of the control member 260. Meanwhile, the output pressure P2 is relatively stable, even at higher flow rates, for the fluid regulating devices with the control members constructed in accordance with the teachings of the present invention. This increased stability, which provides for a more accurate fluid regulating device, is an unexpected result of kicking fluid flow off of the underside of the control member and recessing the fastener, which connects the stem and the control member, within the control member.

From the foregoing, it can be seen that the present disclosure advantageously provides an improved control member for a fluid regulating device that effectively reduces the suction force generated by process fluid flowing through the fluid regulating device. This reduction advantageously increases the stability of the output pressure of the fluid control device, which thereby improves the accuracy of the fluid regulating device.

Preferred embodiments of this invention are described herein, including the best mode or modes known to the inventors for carrying out the invention. Although numerous examples are shown and described herein, those of skill in the art will readily understand that details of the various embodiments need not be mutually exclusive. Instead, those of skill in the art upon reading the teachings herein should be able to combine one or more features of one embodiment with one or more features of the remaining embodiments. Further, it also should be understood that the illustrated embodiments are exemplary only, and should not be taken as limiting the scope of the invention. All methods described herein can be performed in any suitable order unless otherwise indicated herein or otherwise clearly contradicted by context. The use of any and all examples, or exemplary language (e.g., “such as”) provided herein, is intended merely to better illuminate the aspects of the exemplary embodiment or embodiments of the invention, and do not pose a limitation on the scope of the invention. No language in the specification should be construed as indicating any non-claimed element as essential to the practice of the invention.

What is claimed is:

1. A control member for a fluid regulating device having a valve body defining a fluid passageway for a fluid, an actuator assembly coupled to the valve body and comprising an upper casing, a lower casing secured to the upper casing, and a diaphragm assembly disposed between the upper casing and the lower casing, a valve seat disposed in the valve body along the fluid passageway, and a valve stem operatively connected to the diaphragm assembly to move with the diaphragm assembly, the control member operatively connected to the valve stem and movable relative to the valve seat to control fluid flow through the fluid passageway, and comprising:
a top side adapted to engage the valve seat when the control member is arranged in a closed position;
a bottom side; and
a means for reducing a suction force exerted on the bottom side of the control member by fluid flowing proximate to the control member.

2. The control member of claim 1, wherein the means for reducing a suction force exerted on the bottom side of the control member comprises a rim extending outwardly from the bottom side to a position below the bottom side, the rim configured to reduce a downward force exerted on the bottom side of the control member by directing fluid flowing through the fluid passageway away from the bottom side of the control member.

3. The control member of claim 1, wherein the control member comprises a body including the top side and the bottom side, and wherein the means for reducing a suction force exerted on the bottom side of the control member extends outwardly from the body to a position below the bottom side.

4. The control member of claim 3, wherein the means for reducing a suction force exerted on the bottom side of the control member comprises a rim extending outwardly from the bottom side to a position below the bottom side, the rim configured to reduce a downward force exerted on the bottom side of the control member by directing fluid flowing through the fluid passageway away from the bottom side of the control member

5. The control member of claim 4, wherein the rim is radially aligned with a circumferential edge of the body of the control member.

6. The control member of claim 1, wherein the control member comprises a body having a first annular portion and a second annular portion having a diameter greater than a diameter of the first annular portion, and wherein the means for reducing a suction force exerted on the bottom side of the control member comprises the second annular portion.

7. The control member of claim 1, wherein the control member comprises a body having a perimeter edge, and wherein the means for reducing a suction force exerted on the bottom side of the control member comprises a portion of the perimeter edge.

8. A fluid regulating device, comprising:
a valve body having an inlet, an outlet, and a fluid passageway defined therebetween;
an actuator assembly coupled to the valve body, the actuator assembly comprising an upper casing, a lower casing secured to the upper casing, and a diaphragm assembly disposed between the upper casing and the lower casing;
a valve seat disposed in the valve body along the fluid passageway; and
a stem assembly operatively connected to the diaphragm assembly to move with the diaphragm assembly, the stem assembly comprising a valve stem and a control member operatively connected to the valve stem and movable relative to the valve seat to control fluid flow through the fluid passageway,
wherein the control member comprises a body having a top side configured to engage the valve seat when the control member is in a closed position and a bottom side, the control member further comprising a rim extending outwardly from the body to a position below the bottom side, the rim configured to direct fluid flowing through the fluid passageway away from the bottom side of the control member.

9. The fluid regulating device of claim 8, further comprising a fastener configured to connect the control member to the valve stem.

10. The fluid regulating device of claim 9, further comprising a through-bore formed through the control member, the fastener arranged in the through-bore between the top and bottom sides of the control member.

11. The fluid regulating device of claim 9, wherein the fastener is recessed within the control member.

12. The fluid regulating device of claim 8, wherein the rim is radially aligned with a circumferential edge of the body of the control member.

13. The fluid regulating device of claim 8, wherein the rim circumferentially surrounds the bottom side of the control member.

14. A fluid regulating device, comprising:
a valve body having an inlet, an outlet, and a fluid passageway defined therebetween;
an actuator assembly coupled to the valve body, the actuator assembly comprising an upper casing, a lower casing secured to the upper casing, and a diaphragm assembly disposed between the upper casing and the lower casing;
a valve seat disposed in the valve body along the fluid passageway; and
a stem assembly operatively connected to the diaphragm assembly to move with the diaphragm assembly, the stem assembly comprising a valve stem and a control member operatively connected to the valve stem and movable relative to the valve seat to control fluid flow through the fluid passageway,
wherein the control member comprises a top side configured to engage the valve seat when the control member is in a closed position, a bottom side, and a perimeter edge, the perimeter edge having a first portion between the top and bottom sides and a second portion extending outwardly from the first portion to a position below the bottom side, the second portion configured to direct fluid flowing through the fluid passageway away from the bottom side of the control member.

15. The fluid regulating device of claim 14, wherein the second portion of the perimeter edge circumferentially surrounds the bottom side of the control member.

16. The fluid regulating device of claim 14, wherein the second portion of the perimeter edge has a diameter greater than a diameter of the first portion.

17. The fluid regulating device of claim 14, wherein the second portion of the perimeter edge is radially aligned with the first portion of the perimeter edge.

18. The fluid regulating device of claim 14, further comprising a fastener configured to connect the control member to the valve stem.

19. The fluid regulating device of claim 14, further comprising a through-bore formed through the control member, the fastener arranged in the through-bore between the top and bottom sides of the control member.

20. The fluid regulating device of claim 14, wherein the fastener is recessed within the control member.
